(19) United States
(12) Patent Application Publication
(10) Pub. No.: US 2024/0166874 A1
(43) Pub. Date: May 23, 2024

(54) RESIN COMPOSITION

(71) Applicant: NAN YA PLASTICS CORPORATION, TAIPEI (TW)

(72) Inventors: Te-Chao Liao, Taipei (TW); Yu-Ting Liu, Taipei (TW); Hung-Yi Chang, Taipei (TW); Chia-Lin Liu, Taipei (TW); Wei-Ru Huang, Taipei (TW)

(73) Assignee: NAN YA PLASTICS CORPORATION, TAIPEI (TW)

(21) Appl. No.: 18/300,383

(22) Filed: Apr. 13, 2023

(30) Foreign Application Priority Data
Nov. 3, 2022 (TW) 111141999
Jan. 31, 2023 (TW) 112103321

(51) Int. Cl. C08L 79/08; C08K 3/36; C08K 5/5415

(52) U.S. Cl. CPC C08L 79/08; C08K 3/36; C08K 5/5415; C08L 2205/025; C08L 2205/035

(57) ABSTRACT

A resin composition including a modified maleimide resin is provided. The modified maleimide resin is formed from a dicyclopentadiene (DCPD)-based resin having an amino group and a maleic anhydride by a condensation polymerization. The dicyclopentadiene-based resin having an amino group is formed by nitration reaction and hydrogenation reaction of dicyclopentadiene phenolic resin.

### CROSS-REFERENCE TO RELATED APPLICATION

This application claims the priority benefits of Taiwan application serial no. 111141999, filed on Nov. 3, 2022, and Taiwan application serial no. 112103321, filed on Jan. 31, 2023. The entirety of each of the above-mentioned patent applications is hereby incorporated by reference herein and made a part of this specification.

### BACKGROUND

### Technical Field

The invention relates to a resin composition, particularly to a resin composition including a maleimide resin having a main chain including a dicyclopentadiene structure.

### Description of Related Art

With the advancement of science and technology, electronic components are developing towards the goal of lightness, thinness, shortness and smallness. Moreover, the advent of the 5th generation mobile networks (5G) has made the industry's demand for high-frequency transmission, high-speed signal transmission, and low latency continue to increase. Therefore, related fields are currently devoting to develop substrate materials with high glass transition temperature (Tg), low dielectric constant (Dk), low dissipation factor (DO and good heat resistance to satisfy the needs of electronic substrates for dielectric properties (low dielectric constant, low dissipation factor) and heat resistance.

Common substrate materials are, for example, polyphenylene ether resin or cyanate resin, for which these types of resins have good dielectric properties, but their reactivity is high, the reaction rate is too fast, thereby not easy to judge a gel point, which leads to a disadvantage of poor processability.

General bismaleimide resin (mostly aliphatic molecular structure) has good processability, but dielectric properties thereof are poor, and it may not be applied to products with high requirements on dissipation factor (dissipation factor being less than 0.0041). For example, a bismaleimide resin is disclosed in the prior art, which may contain or only contain an aliphatic molecular structure. However, although the dissipation factor of printed circuit boards made of bismaleimide resin with such aliphatic molecular structure may reach 0.0041, the glass transition temperature of the substrate will be greatly reduced. Therefore, the current bismaleimide resins on the market are still required to improve the electrical properties and maintain the characteristics of high glass transition temperature in order to meet the needs of high-frequency printed circuit boards.

### SUMMARY

The invention provides a resin composition, which includes a resin composition having a maleimide resin whose main chain includes a dicyclopentadiene structure. Also, in the application of the resin composition, it is preferable to increase the glass transition temperature, decrease the coefficient of thermal expansion, enhance the peel strength, decrease the water absorption and/or decrease the Dk/Df.

A resin composition of the invention includes a modified maleimide resin. The modified maleimide resin is formed by a condensation polymerization of a dicyclopentadiene (DCPD)-based resin having an amino group and a maleic anhydride, wherein the dicyclopentadiene-based resin having an amino group is formed by nitration reaction and hydrogenation reaction of dicyclopentadiene phenolic resin.

In an embodiment of the invention, an equivalent ratio of a mole number of the amino group of the dicyclopentadiene-based resin having an amino group to a mole number of a maleic anhydride group of the maleic anhydride is 1:1 to 1:10.

A resin composition of the invention includes a modified maleimide resin, which has a structure represented by Formula (1) as follows:

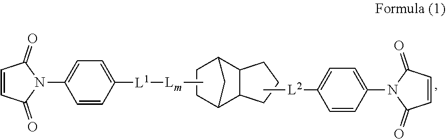

in Formula (1), L represents a dicyclopentadienylene group, a divalent organic group derived from a phenol-based compound or a combination thereof,
L¹ and L² each represent a divalent organic group derived from a phenol-based compound, and,
m represents an integer from 0 to 18.

In an embodiment of the invention, the phenol-based compound includes phenol.

In an embodiment of the invention, L represents

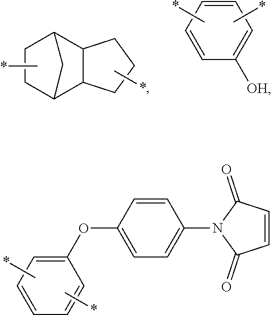

or a combination thereof, wherein * represents a bonding position.

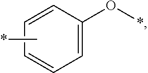

In an embodiment of the invention, L¹ and L² each represent wherein * represents a bonding position.

In an embodiment of the invention, a weight-average molecular weight of the modified maleimide resin is 800 g/mol to 10,000 g/mol.

In an embodiment of the invention, the resin composition further includes a meleimide resin different from the modified maleimide resin described above, a styrene-butadiene-styrene copolymer and a crosslinking agent. Based on a total weight of the modified maleimide resin, the maleimide resin, the styrene-butadiene-styrene copolymer and the crosslinking agent: a weight ratio of the modified maleimide resin is 10 wt % to 40 wt %; a weight ratio of the maleimide resin is 10 wt % to 60 wt %; a weight ratio of the styrene-butadiene-styrene copolymer is 10 wt % to 40 wt %; and a weight ratio of the crosslinking agent is 5 wt % to 25 wt %.

In an embodiment of the invention, based on a calculation of a sum of the weights of the modified maleimide resin, the maleimide resin, the styrene-butadiene-styrene copolymer and the crosslinking agent, the resin composition further includes 1 PHR to 35 PHR of a flame retardant.

In an embodiment of the invention, based on a calculation of a sum of the weights of the modified maleimide resin, the maleimide resin, the styrene-butadiene-styrene copolymer and the crosslinking agent, the resin composition further includes 0.1 PHR to 2 PHR of a peroxide.

In an embodiment of the invention, based on a calculation of a sum of the weights of the modified maleimide resin, the maleimide resin, the styrene-butadiene-styrene copolymer and the crosslinking agent, the resin composition further includes 10 PHR to 60 PHR of an inorganic filler.

In an embodiment of the invention, based on a calculation of a sum of the weights of the modified maleimide resin, the maleimide resin, the styrene-butadiene-styrene copolymer and the crosslinking agent, the resin composition further includes 0.1 PHR to 5.0 PHR of a silane.

In an embodiment of the invention, based on a calculation of a sum of the weights of the modified maleimide resin, the maleimide resin, the styrene-butadiene-styrene copolymer and the crosslinking agent, the resin composition further includes 1 PHR to 35 PHR of a flame retardant, 0.1 PHR to 2 PHR of a peroxide, 10 PHR to 60 PHR of an inorganic filler and 0.3 PHR to 1.0 PHR of a silane.

An electronic component of the invention includes a film layer formed by the resin composition described above.

Based on the above, the resin composition includes a resin composition having a maleimide resin whose main chain includes a dicyclopentadiene structure. Thus, in the application of the resin composition, it is preferable to increase the glass transition temperature, decrease the coefficient of thermal expansion, enhance the peel strength, decrease the water absorption and/or decrease the Dk/Df.

### DESCRIPTION OF THE EMBODIMENTS

The following are embodiments describing the content of the invention in detail. The implementation details provided in the embodiments are for illustrative purposes, and are not intended to limit the scope of protection of the content of the invention. Those with ordinary knowledge in the art may modify or change these implementation details according to the needs of the actual implementation.

A range may be expressed herein as from “about” one particular value to “about” another particular value, which may also be expressed directly as one particular value and/or to another particular value. When expressing a stated range, another embodiment includes from the one particular value and/or to the other particular value. Similarly, when a value is expressed as approximations by a use of the antecedent “about”, it will be understood that the particular value forms another embodiment. It will be further understood that the endpoints of each range are expressly relative or unrelated to the other endpoint.

A non-limited terms (such as possible, may, for example, or other similar terms) as used in the specification refers to a non-essential or optional implementation, inclusion, addition or presence.

All terms (including technical terms and scientific terms) used herein have the same meaning as commonly understood by people having ordinary skills in the art unless otherwise defined. It will also be understood that terms (such as those defined in commonly used dictionaries) should be explained to have meanings consistent with their meanings in the relevant technical context, and should not be interpreted in an idealized or overly formal sense, except clearly defined in the present application.

The “divalent organic group” as used in the specification is an organic group having two bonding positions. And the “divalent organic group” may form two chemical bonds through these two bonding positions.

### Modified Maleimide Resin

The embodiment provides a modified maleimide resin formed from a dicyclopentadiene-based resin having an amino group and a maleic anhydride by a condensation polymerization, wherein the dicyclopentadiene-based resin having an amino group is formed by nitration reaction and hydrogenation reaction of dicyclopentadiene phenolic resin.

Thus, the modified maleimide resin of the embodiment has a structure in which the main chain includes dicyclopentadiene, which makes the modified maleimide resin have good dielectric properties and heat resistance.

Specific examples of commercially available products of dicyclopentadiene resin having a phenol group may include ERM6140 (trade name; manufactured by Songwon Industrial Co., Ltd.; weight-average molecular weight: about 1,300), ERM6105 (trade name; manufactured by Songwon Industrial Co., Ltd.; weight-average molecular weight: about 800), ERM6115 (trade name; manufactured by Songwon Industrial Co., Ltd.; weight-average molecular weight: about 1,100) or other suitable dicyclopentadiene phenolic resin.

### Preparation Method of Modified Maleimide Resin

First, the dicyclopentadiene-based resin having an amino group is formed by performing a dicyclopentadiene phenolic resin to nitration reaction and hydrogenation reaction. The method of nitration reaction and hydrogenation reaction of the dicyclopentadiene phenolic resin is not particularly limited, for example, well-known nitration reaction and hydrogenation reaction may be performed, which will not be described in detail here. Next, the dicyclopentadiene-based resin having an amino group and the maleic anhydride are performed to a condensation polymerization to form a modified maleimide resin. In this embodiment, an equivalent ratio of a mole number of the amino group of the dicyclopentadiene-based resin having an amino group to a mole number of a maleic anhydride group of the maleic anhydride is about 1:1 to 1:10. In an embodiment, the aforementioned molar ratio may have a better reaction yield (such as lower side reaction yield) and/or a better reagent (such as reaction reagent or neutralizing reagent, but not limited thereto) usage rate. For example, if a proportion of the maleic anhydride is too high, it may be required to add more alkali (such as sodium bicarbonate, but not limited thereto) in the subsequent treatment (such as product extraction, waste liquid treatment, but not limited thereto) for acid-base neutralization. In an embodiment, an equivalent ratio of a mole number of the amino group of the dicyclopentadiene-based resin having an amino group to a mole number of a maleic anhydride group of the maleic anhydride is about 1:1 to 1:3.

The modified maleimide resin has a structure represented by Formula (1) as follows. In this embodiment, a weight-average molecular weight of the modified maleimide resin is about 800 g/mol to 10,000 g/mol. In an embodiment, a weight-average molecular weight of the modified maleimide resin is about 1,000 g/mol to 4,000 g/mol.

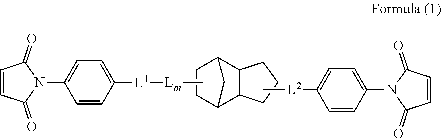

In Formula (1), L represents a dicyclopentadienylene group, a divalent organic group derived from a phenol-based compound or a combination thereof, preferably a combination of the dicyclopentadienylene group and the divalent organic group derived from the phenol-based compound, and the divalent group is preferably a divalent group including a maleimide group; and
L¹ and L² each represent a divalent organic group derived from a phenol-based compound;
m represents an integer from 0 to 18, preferably an integer from 2 to 10.

L, L¹ and L² may represent a divalent group derived from phenol. In this embodiment, L may represent

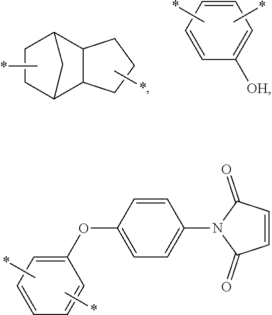

or a combination thereof, preferably a combination of

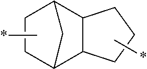

and

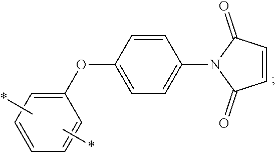

* represents a bonding position. L¹ and L² may each represent

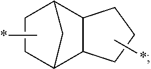

* represents a bonding position.

In this embodiment, the modified maleimide resin may have a structure represented by Formula (2) as follows. In this embodiment, the modified maleimide resin is a modified multi-maleimide resin.

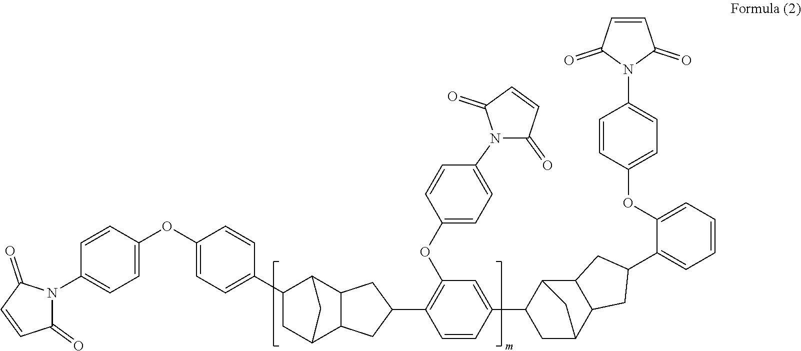

In formula (2), m represents an integer from 0 to 18, preferably an integer from 2 to 10.

In an embodiment, a weight-average molecular weight (which may be abbreviated as Mw) may be measured by gel permeation chromatograph (GPC). The gel permeation chromatograph may be calibrated with a polystyrene (PS) having a standard molecular weight, set flow rate being about 1.0 mL/min, and tetrahydrofuran (THF) used as the mobile phase.

If a weight-average molecular weight of the modified maleimide resin is greater than about 10,000 g/mol, the corresponding modified maleimide resin may be less easy to be mixed with other resins to form a resin composition, and has a problem of difficult to operate.

If a weight-average molecular weight of the modified maleimide resin is less than about 800 g/mol, the corresponding modified maleimide resin may have low solubility, and is easy to have a problem of resin precipitation.

In the aforementioned modified maleimide resin, the main chain thereof includes a maleimide resin having a dicyclopentadiene structure (DCPD-MI) and it has a structure represented by Formula (2) (m represents an integer from 0 to 18). In addition, in the subsequent description, it may be abbrevitated to “self-made DCPD-MI resin” for brevity.

### Maleimide Resin Composition

In this embodiment, based on a weight of a unit of a maleimide resin composition, the maleimide resin composition includes about 10 wt % to 40 wt % of the self-made DCPD-MI resin, about 10 wt % to 40 wt % of a styrene-butadiene-styrene copolymer (SBS copolymer), about 5 wt % to 25 wt % of a crosslinking agent, about 10 wt % to 60 wt % of bismaleimide resin (BMI resin).

In an embodiment, in the maleimide resin composition, based on a calculation of a sum of the weights of the self-made DCPD-MI resin, the styrene-butadiene-styrene copolymer, the crosslinking agent and the bismaleimide resin, the maleimide resin composition may further include about 1 PHR (parts per hundred parts of resin) to 35 PHR of a flame retardant. That is, if the total weight of the self-made DCPD-MI resin, the styrene-butadiene-styrene copolymer, the crosslinking agent and the bismaleimide resin is 100 units, it may further include 1 unit by weight to 35 units by weight of flame retardant added.

In an embodiment, in the maleimide resin composition, based on a calculation of a sum of the weights of the self-made DCPD-MI resin, the styrene-butadiene-styrene copolymer, the crosslinking agent and the bismaleimide resin, the maleimide resin composition may further include about 10 PHR to 60 PHR of a granular inorganic filler.

In an embodiment, in the maleimide resin composition, based on a calculation of a sum of the weights of the self-made DCPD-MI resin, the styrene-butadiene-styrene copolymer, the crosslinking agent and the bismaleimide resin, the maleimide resin composition may further include about 0.1 PHR to 2 PHR of a peroxide.

In an embodiment, an addition of a crosslinking agent may increase the degree of crosslinking between a resin and/or a corresponding polymer. In an embodiment, the crosslinking agent may include an allyl group. In an embodiment, the crosslinking agent may include triallyl cyanurate (TAC), triallyl isocyanurate (TAIC), trimethallyl isocyanurate (TMAIC), diallyl phthalate, divinylbenzene, triallyl trimellitate, or a combination thereof.

In an embodiment, an addition of a flame retardant may enhance the degree of flame resistance or flame retardancy of the maleimide resin composition. The “flame resistance” or “flame retardancy” used herein mean that the referenced object (e.g., film, layer or structure) may pass the flame retardancy criteria of the standard test method. For example, taking the UL94 plastic flammability standard (Test for Flammability of Plastic Materials for Parts in Devices and appliances) issued by Underwriters Laboratories Inc (UL) as an example, the degree is at least the HB level.

In an embodiment, the flame retardant includes a bromine-based flame retardant, a phosphorus-based flame retardant, or a combination thereof.

In an embodiment, the bromine-based flame retardant includes Saytex BT 93W (trade name; ethylene bistetrabromophthalimide) flame retardant, Saytex BT93 (trade name), Saytex 120 (trade name; tetradecabromodiphenoxybenzene) flame retardant, Saytex 8010 (trade name; ethane-1,2-bis (pentabromophenyl)) flame retardant, Saytex 102 (trade name; decabromo diphenoxy oxide) flame retardant, or a combination thereof, which are produced by Albemarle Corporation of the United States agent.

In an embodiment, the phosphorus-based flame retardant may include sulphosuccinic acid ester, phosphazene, ammonium polyphosphate, melamine polyphosphate, melamine cyanurate, or a combination thereof. For example, the phosphorus-based flame retardant may include triphenyl phosphate (TPP), resorcinol bis(diphenyl phosphate) (RDP), bisphenol A bis(diphenyl phosphate) (BPAPP), resorcinol diphosphate (e.g. CR-733S (trade name) produced by Daihachi Chemical Industry Co., Ltd.), resorcinol-bis(di-2,6-dimethylphenyl phosphate) (e.g. PX-200 (trade name) produced by Daihachi Chemical Industry Co., Ltd.), SPB-100 phosphorus-based flame retardant produced by Otsuka Chemical Co., Ltd., or a combination thereof.

In an embodiment, an addition of an inorganic filler may enhance the viscosity of the maleimide resin composition. For example, the inorganic filler may be silicon dioxide, titanium dioxide, aluminum hydroxide, aluminum oxide, magnesium hydroxide, magnesium oxide, calcium carbonate, boron oxide, calcium oxide, strontium titanate, barium titanate, calcium titanate, magnesium titanate, boron nitride, aluminum nitride, silicon carbide, cerium oxide, or a combination thereof.

In an embodiment, the silicon dioxide added as an inorganic filler may include fused or crystalline silicon dioxide. In an embodiment, in consideration of the dielectric properties when applied to a copper foil substrate, fused silicon dioxide is more preferred.

In an embodiment, the titanium dioxide added as an inorganic filler may include titanium dioxide in a rutile, anatase or brookite configuration. In an embodiment, in consideration of the dielectric properties when applied to a copper foil substrate, the titanium dioxide in a rutile configuration is more preferred.

In an embodiment, the peroxide may include azobisisobutyronitrile (CAS No. 78-67-1), benzoyl peroxide (CAS No. 94-36-0), and dicumyl peroxide (CAS No. 80-43-3), or a combination thereof.

In an embodiment, the maleimide resin composition is soluble in an appropriate solvent and is suitable for preparing a resin solution to use as a paint of coating.

In an embodiment, the appropriate solvent may include but not limited to toluene, methyl isobutyl ketone (MIBK), methyl ethyl ketone (MEK), dimethylacetamide (DMAC), dimethylformamide (DMF), proprylene glycol monomethyl ether (PM), or a co-solvent including thereof.

In an embodiment, in the maleimide resin composition, based on a calculation of a sum of the weights of the self-made DCPD-MI resin, the styrene-butadiene-styrene copolymer, the crosslinking agent and the bismaleimide resin, the maleimide resin composition may further include about 0.1 PHR to 5 PHR of a siloxane coupling agent.

In an embodiment, in consideration of applied to a copper foil substrate, the siloxane coupling agent may enhance the compatibility and/or the degree of crosslinking of the bonded material (such as glass fiber cloth and/or powder), thereby improving the peel strength and/or heat resistance of the copper foil substrate. In an embodiment, the siloxane coupling agent may have at least one of an acryl group and a vinyl group. For example, the siloxane coupling agent may include a siloxane coupling agent of Z6030 (model name) or a siloxane coupling agent of Z6300 (model name) manufactured by Dow Corning Inc. An end of the siloxane coupling agent of Z6030 has an acryl group. An end of the siloxane coupling agent of Z6300 has a vinyl group.

In an embodiment, the maleimide resin composition may be suitable for forming an insulating film of an electronic product, and it may be used in an electronic product, for which the specifications thereof may be as follows: a dielectric constant (Dk) being less than about 3.2 (for example, about 3.13 to 3.29); a dissipation factor (DO being less than about 0.0030 (for example, about 0.0022 to 0.0028); a glass transition temperature being about 230° C. to 260° C.; a coefficient of thermal expansion (CTE) being less than about 20 ppm/° C.; a peel strength being greater than about 3.5 lb/in (for example, greater than or equal to 4.0 lb/in; or about 4.0 lb/in to 5.4 lb/in); and/or a water absorption being less than or equal to about 0.3% (for example, 2 hours water absorption being less than or equal to about 0.3%).

### Manufacture of Copper Foil Substrate

A manufacturing method of a copper foil substrate may be as follows.

The maleimide resin composition of the embodiment may be dissolved in a suitable solvent and mixed to form a resin varnish, and a copper foil substrate is prepared by a known method. The known method for preparing a copper foil substrate may be, for example: impregnating 2116 fiberglass cloth with the resin varnish, and then drying at about 170° C. (temperature of an impregnation machine) for several minutes to obtain a dried prepreg with a melt viscosity of about 4000 to 12000 poise by adjusting and controlling the drying time. Then, a copper foil substrate of an embodiment may be formed by stacking four pieces of prepreg layer by layer between two pieces of copper foil with a thickness of about 35 μm, and performing a pressing step (details are described later).

The conditions/processes of the pressing step are exemplified as follows:
Step 1: the temperature is raised from about 80° C. to about 195° C. at a speed of about 0.5 hour (which may be recorded as: 85 [symbol] 195° C., 0.5 hr).
Step 2: the pressure is raised from about 7 kg/cm² to about 25 kg/cm² at a speed of about 0.5 hour (which may be recorded as: 7 [symbol] 25 kg/cm^{2 , 0.5} hr).
Step 3: the pressing is performed at a temperature of about 195° C. and a pressure of about 25 kg/cm² for about 2.0 hours (which may be recorded as: 195° C./25 kg/cm², 2.0 hr).

### Examples and Comparative Examples

Examples and comparative examples are shown below to specifically describe the invention, but the invention is not limited by the following examples.

### Examples and Comparative Examples of Modified Maleimide Resin

Example 1 and Comparative example 1 of the modified maleimide resin are described below:

### Example 1

Dicyclopentadiene phenolic resin including about 1 mole hydroxyl group (trade name: ERM6140, manufactured by Songwon Industrial Co., Ltd.; weight average molecular weight: about 1,300) and about 1.25 mole of 4-halonitrobenzene (halogen may be fluorine, chlorine, bromine or iodine) were added in about 6 mole of dimethylacetamide (DMAC) as a reaction solvent, and reacted at a temperature of about 120° C. for about 300 minutes to perform a nitration reaction. Next, hydrogen gas was inserted thereto, and reacted at a temperature of about 90° C. for about 480 minutes to perform a hydrogenation reaction to form a dicyclopentadiene-based resin having an amino group. Next, about 3 mol of maleic anhydride and about 9.7 wt % of methylbenzenesulfonic acid were added thereto, and reacted at a temperature of about 120° C. for about 420 minutes. The modified maleimide resin of Example 1 was obtained, which is a maleimide resin whose main chain includes a dicyclopentadiene structure (i.e., self-made DCPD-MI) and has a structure represented by Formula (2) (m representing an integer from 0 to 18). The obtained modified maleimide resin was evaluated by each of the following evaluation methods, and the results thereof are as shown in Table 1.

### Comparative Example 1

The maleimide resin of Comparative example 1 is a commercially available bismaleimide resin BMI-70 (trade name; manufactured by K⋅I Chemical Industry Co., LTD.; weight average molecular weight: about 443). It was evaluated by each of the following evaluation methods, and the results thereof are as shown in Table 1.

TABLE 1

| | Example 1 | Comparative example 1 |
|---|---|---|
| Maleimide resin | self-made | BMI-70 |
| | DCPD-MI | |
| Tg (unit:° C.) | 212 | 204 |
| Peel strength (unit: lb/in) | 6.9 | 6.2 |
| Water absorption (unit: %) | 0.28 | 0.36 |
| Dielectric constant (Dk) | 3.1 | 3.3 |
| Dissipation factor (Df) | 0.0023 | 0.0033 |

### Evaluation Methods

a. Glass Transition Temperature (Tg)

The prepared modified maleimide resin was measured for a glass transition temperature (Tg) via a dynamic mechanical analyzer (DMA). When the Tg is greater, the modified maleimide resin has good resistance to phase changes, that is, good heat resistance.
Heating rate: about 10° C./min
Temperature range: about 30° C. to 300° C. (heating, cooling, heating)
   b. Peel Strength

The prepared modified maleimide resin was coated on a substrate, and baked at a temperature of about 120° C. for about 2 minutes to form a resin film. Then, copper foils were laminated on an upper surface and a lower surface of the resin film, and hot pressed at a temperature of about 210° C. for about 3 hours to form a film with thickness of about 200 μm. Next, the film was measured for a peel strength via a universal tensile machine. When the peel strength is greater, the modified maleimide resin has good resistance to peeling from the substrate, that is, good peel resistance.

c. Water Absorption

The prepared modified maleimide resin was placed in a constant temperature and humidity box, and the water absorption was measured when the temperature reached about 85° C. and the humidity reached about 85%. When the water absorption is smaller, the modified maleimide resin has good moisture resistance.

d. Dielectric Constant (Dk)

The prepared modified maleimide resin was coated on a common substrate which may be used for evaluating the dielectric constant, and baked at a temperature of about 120° C. for about 2 minutes, and then hot pressed at a temperature of about 210° C. for about 3 hours to form a film with thickness of about 100 μm. Next, the film was measured for a dielectric constant (Dk) at a frequency of about 10 GHz via a dielectric analyzer (model: E4991A; manufactured by Agilent Technologies, Inc.). When the dielectric constant is smaller, the modified maleimide resin has good dielectric property.

e. Dissipation Factor (Df)

The prepared modified maleimide resin was coated on a common substrate which may be used for evaluating the dissipation factor, and baked at a temperature of about 120° C. for about 2 minutes, and then hot pressed at a temperature of about 210° C. for about 3 hours to form a film with thickness of about 100 μm. Next, the film was measured for a dissipation factor (Df) at a frequency of about 10 GHz via a dielectric analyzer (model: E4991A; manufactured by Agilent Technologies, Inc.). When the dissipation factor is smaller, the modified maleimide resin has good dielectric property.

### Evaluation Results

It may be seen from [Table 1] that when the modified maleimide resin has a structure in which the main chain includes dicyclopentadiene (Example 1), the modified maleimide resin has good heat resistance, peel resistance, moisture resistance and dielectric properties at the same time.

In addition, compared to the maleimide resin (Comparative example 1) in which the main chain does not have a dicyclopentadiene structure, the modified maleimide resin (Example 1) in which the main chain has a dicyclopentadiene structure has greater glass transition temperature, greater peel strength, smaller water absorption, smaller dielectric constant and smaller dissipation factor, that is, better heat resistance, peel resistance, moisture resistance and dielectric properties.

### Examples and Comparative Examples Applied to Copper Foil Substrate

A resin varnish composition was formed by mixing the formula composition ratio shown in [Table 2], and then a copper foil substrate was prepared by the aforementioned method.

The “BMI-2300” used in [Comparative example 2], [Example 2] and [Example 3] is BMI-2300 series resin sold by Daiwa Fine Chemicals (Taiwan) Co., Ltd.

The “BMI-70” used in [Comparative example 2] is BMI-70 serier resin sold by K⋅I Chemical Industry Co., LTD.

The “self-made DCPD-MI” used in [Example 2] and [Example 3] is a maleimide resin whose main chain includes a dicyclopentadiene structure (DCPD-MI) of [Example 1].

The styrene-butadiene-styrene copolymer (SBS copolymer) used in [Comparative example 2], [Example 2] and [Example 3] may be purchased commercially (e.g. Formosa Petrochemical Corporation).

The crosslinking agent used in [Comparative example 2], [Example 2] and [Example 3] may include a polycyanate of TAIC series (trade name) sold by Mitsubishi Chemical Co., Ltd.

The flame retardant used in [Comparative example 2], [Example 2] and [Example 3] may include a flame retardant of OP935 series (trade name) sold by Clariant AG.

The inorganic filler used in [Comparative example 2], [Example 2] and [Example 3] may include a silicon dioxide filler of 525ARI series (trade name) sold by Sibelco Company.

The siloxane used in [Comparative example 2], [Example 2] and [Example 3] may include a siloxane coupling agent sold by Dow Corning Inc.

TABLE 2

| | | Compar- | | |
|---|---|---|---|---|
| | | ative | Exam- | Exam- |
| | | example 2 | ple 2 | ple 3 |
| Basic | BMI-2300 (wt %) | 30 | 30 | 15 |
| formula | BMI-70 (wt %) | 20 | — | — |
| | Self-made DCPD-MI | — | 20 | 35 |
| | (wt %) | | | |
| | SBS (wt %) | 35 | 35 | 35 |
| | Crosslinking agent (wt %) | 15 | 15 | 15 |
| Added | Flame retardant (PHR) | 30 | 30 | 30 |
| Formula | Inorganic filler (PHR) | 50 | 50 | 50 |
| | Peroxide (PHR) | 1.0 | 1.0 | 1.0 |
| | Siloxane (PHR) | 0.5 | 0.5 | 0.5 |
| Evalua- | B-Stage (° C.) | 130 | 130 | 130 |
| tion | Tg (° C.) | 265 | 251 | 246 |
| | CTE (ppm/° C. @ 20° C.) | 14 | 15 | 16 |
| | Peel strength (lb/in) | 3.24 | 4.50 | 4.90 |
| | Water absorption @PCT | 0.28 | 0.22 | 0.18 |
| | ½ hr (%) | | | |
| | Heat resistance @PCT | Yes | Yes | Yes |
| | ½ hr | | | |
| | Water absorption @PCT | 0.39 | 0.28 | 0.24 |
| | 2 hr (%) | | | |
| | Heat resistance @PCT 2 hr | Yes | Yes | Yes |
| | Dk (10 GHz) | 3.23 | 3.18 | 3.15 |
| | Df (10 GHz) | 0.00323 | 0.00264 | 0.00236 |

### Evaluation Methods

a. Glass Transition Temperature (Tg)

Similar to the method described above, a film was prepared by a resin composition of each formulas above and measured for a glass transition temperature (Tg) via a dynamic mechanical analyzer (DMA).

b. Coefficient of Thermal Expansion (CTE)

Similar to the method described above, a film was prepared by a resin composition of each formulas above and measured for a coefficient of thermal expansion (CTE) via a thermomechanical analysis (TMA) at a heating rate about 20° C./min.

c. Peel Strength

Similar to the method described above, a film was prepared by a resin composition of each formulas above and measured for a peel strength via a universal tensile machine according to IPC-TM-650, Method 2.4.8.

d. Water Absorption

After a 5 cm×5 cm square test specimen was placed in an oven at about 105° C. for an appropriate measurement time (for example, about ½ hour; or about 2 hours), the test specimen was put in a pressure cooker. The ambient condition in the pressure cooker is about 2 atm×120° C. After about 120 minutes in the pressure cooker, the weight difference of the test specimen before and after the pressure cooker÷the initial weight of the test specimen×100% was recorded, which is the water absorption.

e. Heat Resistance

The test method is to immerse the test specimen treated in the pressure cooker into a soldering furnace at 288±5° C., and then observe the test specimen. If there is no delamination, the heat resistance may be recorded as “Yes”.

f. Dielectric Constant (Dk)

The test method is to bake an about 5 cm×5 cm square test specimen which is a copper foil substrate with the copper foil removed in an oven at about 105° C. for about 2 hours to measure the thickness via a thickness measuring instrument. Then, the test specimen was clamped into a dielectric analyzer (model: E4991A; manufactured by Agilent Technologies, Inc.) to measure for a dielectric constant (Dk) data of 3 points and take an average value.

g. Dissipation Factor (Df)

The test method is to bake an about 5 cm×5 cm square test specimen which is a copper foil substrate with the copper foil removed in an oven at about 105° C. for about 2 hours to measure the thickness via a thickness measuring instrument. Then, the test specimen was clamped into a dielectric analyzer (model: E4991A; manufactured by Agilent Technologies, Inc.) to measure for a dissipation factor (Df) data of 3 points and take an average value.

### Evaluation Results

It may be seen from the experiment results in [Table 2] that in [Example 2] to [Example 3], as the content of the self-made DCPD-MI (i.e., maleimide resin whose main chain includes a dicyclopentadiene structure) increases from about 20% to about 35%, the water absorption may be reduced, Dk value drops from about 3.18 to less than about 3.15, and Df value drops from about 0.00264 to less than about 0.00236.

Under the condition of the same proportion, it may be seen from the experimental results of [Example 2] to [Example 3] and [Comparative Example 2] that when using “a maleimide resin whose main chain includes a dicyclopentadiene structure” of an embodiment of the invention, in the application of the copper foil substrate, it is preferable to increase the glass transition temperature, decrease the coefficient of thermal expansion, enhance the peel strength, decrease the water absorption and/or decrease the Dk/Df. Also, compared with the use of traditional resins, other properties may be equivalent or within the corresponding standard specifications.

### INDUSTRIAL APPLICABILITY

In addition, the maleimide resin according to the aforementioned embodiments of the invention may be directly or indirectly applied to copper foil substrates, and may be further processed to become other livelihood, industrial or suitable electronic components or electronic products (such as circuit board or copper foil substrate).

What is claimed is:

1. A resin composition, comprising:
a modified maleimide resin, formed by a condensation polymerization of a dicyclopentadiene-based resin having an amino group and a maleic anhydride, wherein the dicyclopentadiene-based resin having an amino group is formed by nitration reaction and hydrogenation reaction of dicyclopentadiene phenolic resin.

2. The resin composition according to claim 1, wherein an equivalent ratio of a mole number of an amino group of the dicyclopentadiene-based resin having an amino group to a mole number of a maleic anhydride group of the maleic anhydride is 1:1 to 1:10.

3. The resin composition according to claim 1, wherein a weight average molecular weight of the modified maleimide resin is 800 g/mol to 10,000 g/mol.

4. The resin composition according to claim 1, further comprising:
a maleimide resin, different from the modified maleimide resin;
a styrene-butadiene-styrene copolymer; and
a crosslinking agent,
wherein based on a total weight of the modified maleimide resin, the maleimide resin, the styrene-butadiene-styrene copolymer and the cros slinking agent:
a weight ratio of the modified maleimide resin is 10 wt % to 40 wt %;
a weight ratio of the maleimide resin is 10 wt % to 60 wt %;
a weight ratio of the styrene-butadiene-styrene copolymer is 10 wt % to 40 wt %; and
a weight ratio of the crosslinking agent is 5 wt % to 25 wt %.

5. The resin composition according to claim 4, based on a calculation of a sum of the weights of the modified maleimide resin, the maleimide resin, the styrene-butadiene-styrene copolymer and the crosslinking agent, further comprising:
1 PHR to 35 PHR of a flame retardant;
0.1 PHR to 2 PHR of a peroxide;
10 PHR to 60 PHR of an inorganic filler; or
0.1 PHR to 5.0 PHR of a silane.

6. The resin composition according to claim 4, based on a calculation of a sum of the weights of the modified maleimide resin, the maleimide resin, the styrene-butadiene-styrene copolymer and the crosslinking agent, further comprising:
1 PHR to 35 PHR of a flame retardant;
0.1 PHR to 2 PHR of a peroxide;
10 PHR to 60 PHR of an inorganic filler; and
0.3 PHR to 1.0 PHR of a silane.

7. A resin composition, comprising:
a modified maleimide resin, having a structure represented by Formula (1) as follows: 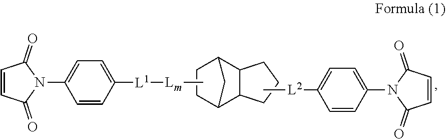
in Formula (1), L represents a dicyclopentadienylene group, a divalent organic group derived from a phenol-based compound or a combination thereof,
L¹ and L² each represent a divalent organic group derived from a phenol-based compound, and
m represents an integer from 0 to 18.

8. The resin composition according to claim 7, wherein:
the phenol-based compound includes phenol;
L represents 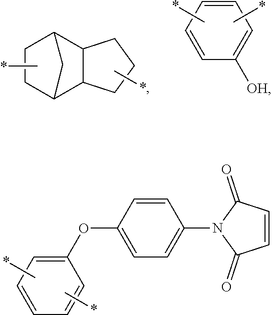
or a combination thereof, wherein * represents a bonding position; or
L¹ and L² each represent 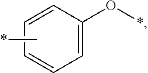
wherein * represents a bonding position.

9. The resin composition according to claim 7, wherein a weight average molecular weight of the modified maleimide resin is 800 g/mol to 10,000 g/mol.

10. The resin composition according to claim 7, further comprising:
a maleimide resin, different from the modified maleimide resin;
a styrene-butadiene-styrene copolymer; and
a crosslinking agent,
wherein based on a total weight of the modified maleimide resin, the maleimide resin, the styrene-butadiene-styrene copolymer and the cros slinking agent:
a weight ratio of the modified maleimide resin is 10 wt % to 40 wt %;
a weight ratio of the maleimide resin is 10 wt % to 60 wt %;
a weight ratio of the styrene-butadiene-styrene copolymer is 10 wt % to 40 wt %; and
a weight ratio of the crosslinking agent is 5 wt % to 25 wt %.

11. The resin composition according to claim 10, based on a calculation of a sum of the weights of the modified maleimide resin, the maleimide resin, the styrene-butadiene-styrene copolymer and the crosslinking agent, further comprising:
1 PHR to 35 PHR of a flame retardant;
0.1 PHR to 2 PHR of a peroxide;
10 PHR to 60 PHR of an inorganic filler; or
0.1 PHR to 5.0 PHR of a silane.

12. The resin composition according to claim 11, based on a calculation of a sum of the weights of the modified maleimide resin, the maleimide resin, the styrene-butadiene-styrene copolymer and the crosslinking agent, further comprising:
1 PHR to 35 PHR of a flame retardant;
0.1 PHR to 2 PHR of a peroxide;
10 PHR to 60 PHR of an inorganic filler; and
0.3 PHR to 1.0 PHR of a silane.

13. An electronic component, comprising:
a film layer formed by the resin composition according to claim 7.
